(19) United States
(12) Patent Application Publication
(10) Pub. No.: US 2006/0256468 A1
(43) Pub. Date: Nov. 16, 2006

(54) Disk drive unit having reduced electrical power consumption

(76) Inventors: Ralph Kurt, Eindhoven (NL); Michael Adrianus Henricus Van Der Aa, Eindhoven (NL); Wouter Harry Jacinth Rensen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,400

(22) PCT Filed: Feb. 12, 2004
(86) PCT No.: PCT/IB04/50105

§ 371 Date: Aug. 18, 2005

(30) Foreign Application Priority Data
Feb. 25, 2003 (EP) 03100451.8

(51) Int. Cl. G11B 5/016

(52) U.S. Cl. 360/99.04

(57) ABSTRACT

A disk drive unit for a removable disk (D), in particular for use in mobile devices, comprises a spindle (1) driven by an electric motor (2) and supporting the disk (D) in its operating position. It further comprises one or two loading mechanisms (4A and 4B) to load mechanical energy into a storage mechanism (5) for storing the loaded energy. A release mechanism (6) is provided to release the stored energy stepwise to the spindle in order to assist during a plurality of start-ups of the disk rotation. The two loading mechanisms (4A and 4B) are adapted to load mechanical energy provided by the user during insertion of the disk and energy released during the deceleration of the rotation of the disk, respectively. The electrical power consumption of the disk drive unit is reduced by the storage of the mechanical energy and its stepwise release.

The invention relates to a disk drive unit for a removable disk in accordance with the preamble of claim 1.

Disk drive units of this type are known in many embodiments. The electrical power consumption of this kind of disk drives is an important issue, especially if they are used in mobile devices since these mobile devices often suffer from limited power budgets.

U.S. Pat. No. 5,513,055 discloses a device comprising a disk drive unit for a removable disk with a storage mechanism for mechanical energy which is provided by the user during the insertion of the disk. The stored mechanical energy is released during the ejection of the disk, in order to reduce the amount of electrical power which is required for the ejection.

It is an object of the present invention to provide a disk drive unit for a removable disk, wherein the electrical power consumption is further reduced.

In order to accomplish that objective, the disk drive unit according to the invention is characterized by the features of the characterizing portion of claim 1.

In the disk drive unit according to claim 1, the release mechanism is connectable to the spindle in order to release the stored energy to the spindle, thereby assisting in bringing the disk into rotation. The use of such energy loading and release mechanisms reduces the amount of electricity consumed by a motor during the acceleration of the rotation of the disk as at least part of the start-up energy is delivered by the mechanical power supplied by the user.

According to the embodiment of claim 2, there is provided a storage mechanism, which has the advantage that the loaded energy can be released at any given time that is desired. Until that time of release, the energy is stored in the storage mechanism.

According to the embodiment of claim 3, the release mechanism is adapted to release the stored energy stepwise. The advantage of such a release mechanism is that the stored mechanical energy can be released in dosed form in order to assist in bringing the disk into rotation during a number of cycles per insertion of the disk. This energy provided by the user is normally sufficient to accelerate the spindle and disk dozens of times. This is particularly useful in devices where the disk drive will operate in a so-called burst mode, which already provides an overall energy saving in comparison with continuous operation. In such a mode, data is read from the disk at an effective high rate and placed in a buffer. This takes only a few seconds, after which the buffer contains sufficient data for reading data from the disk for a longer time, for example 1 minute. For one hour's playing time, a disk must be accelerated about 50 times, depending on the buffer time.

In the embodiment of the invention according to claim 15, the disk drive unit comprises a second loading mechanism which is connectable to the spindle in order to load mechanical energy from the spindle during deceleration of the spindle and the disk. Due to such a second loading mechanism, the rotation of the disk will not just run out freely after a burst-cycle, but the mechanical energy of the rotating disk is stored into the storage mechanism in order to increase the amount of energy stored therein. In this manner more mechanical energy can be stored in the storage mechanism in order to reduce the electrical power consumption further.

Energy loading mechanisms absorbing and storing kinetic energy of a spindle in order to be used again during a following acceleration of the spindle are known per se, e.g. from U.S. Pat. No. 5,572,505 or JP-A-11-296956.

The disk drive unit according to the invention may be built in into a device for reading and/or writing a data disk, or may be built in into a cartridge of a disk. In the former case, the spindle is adapted to be coupled to a hub of the disk, and the disk drive unit comprises an electric motor operatively coupled to the spindle to rotate the spindle.

In the latter case, the spindle of the disk drive unit is integrated with the disk. The cartridge has electrical and mechanical connections to the disk drive of the reading and/or writing device.

These and other aspects of the invention will be apparent from and elucidated with reference to the embodiment(s) described hereinafter by way of example.

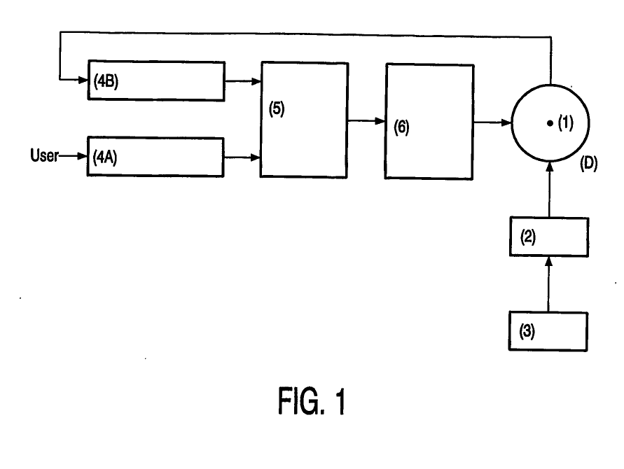

FIG. 1 is a diagram representing the energy flow in an embodiment of the disk drive unit according to the invention.

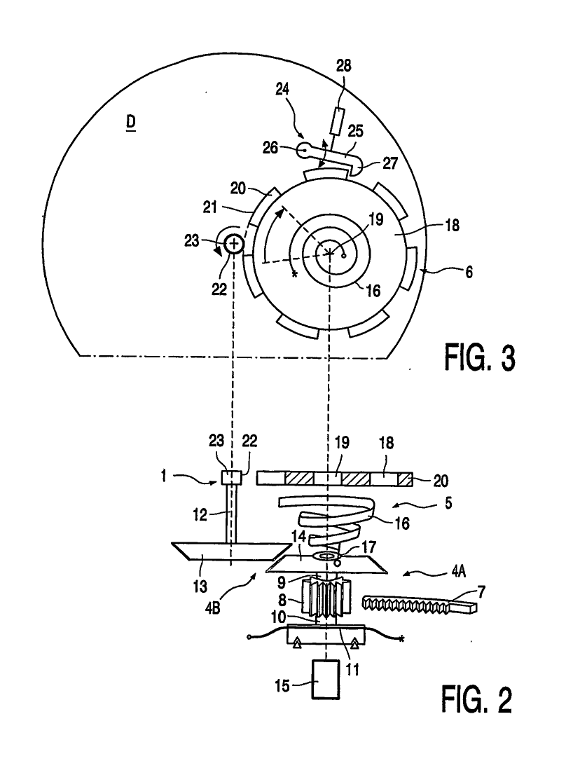

FIG. 2 is a very schematic exploded side elevation of an embodiment of the disk drive unit according to the invention.

FIG. 3 is a plan view of the part of the disk drive unit of FIG. 2.

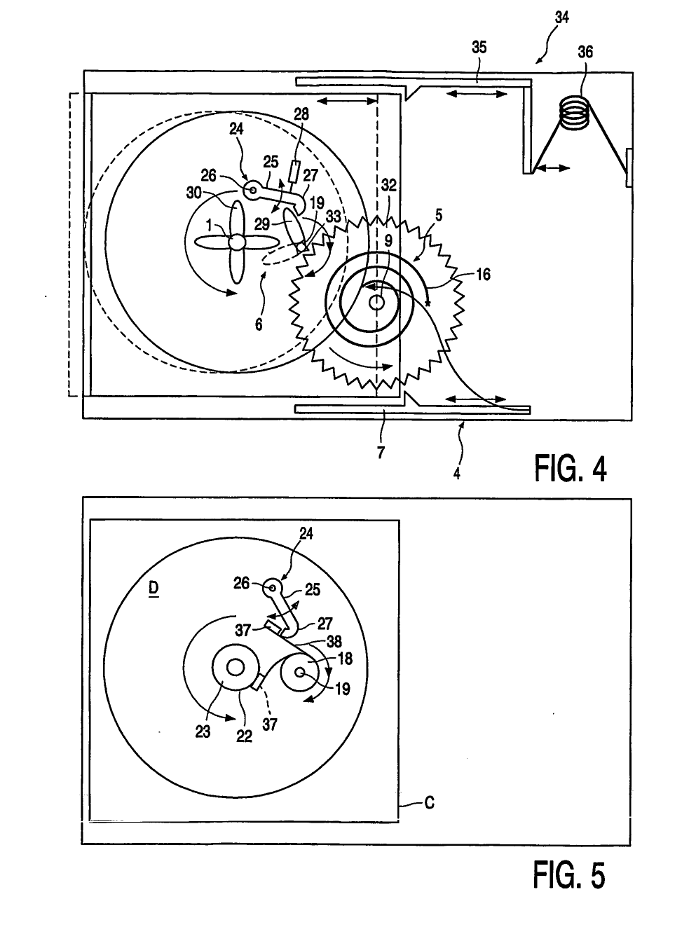

FIG. 4 is a very schematic sketch of an alternative embodiment of the release mechanism of a disk drive unit.

FIG. 5 is a sketch similar to FIG. 4 showing an alternative embodiment of the release mechanism only.

The drawings show embodiments of a disk drive unit. This disk drive unit may be used in a device for reading and/or writing data from or on a disk D, such as an optical disk or the like. The device in which this disk drive unit is used is particularly a mobile or portable device, for example a mobile phone which is provided with an exchangeable optical data disk. The disk may be accommodated in a cartridge C. The mobile device will have a housing in which the disk drive unit is accommodated. The housing will be provided with an opening allowing insertion of the disk from an insertion position into an operating position about a spindle of the disk drive unit and ejection of the disk from the operating position into a released position.

In one particular application of the disk drive unit, the unit is designed to drive very small disks (for example having a diameter of 30 mm). Such a disk drive unit may, for example, operate in a so-called burst mode, which saves energy in comparison with continuous operation. Data is read from the disk at an effective high rate of e.g. 33 Mbit/s and placed in a buffer of typically 8 MB. For example, the data user rate for a certain application is 1 Mbit/s and the acceleration of the disk takes 1 second. This acceleration causes strong energy losses due to static and dynamic friction (bearing friction and air friction), inertia of the disk and the motor, and adaptation of the electrical phase of the electric motor. After acceleration, the power dissipation of the drive unit reduces typically by a factor of 10. In this constant-speed phase, the buffer is filled with data in about 2 seconds. Then, the motor can be stopped and data can be read from the buffer during approximately 1 minute. If the disk contains 1 hour of music, the disk needs to be accelerated about 50 times during playback of this disk.

The invention proposes to reduce the electrical power consumption, especially during acceleration of the spindle and the disk, by using mechanical energy to assist in accelerating the disk.

FIG. 1 very schematically shows the energy flow in a disk drive unit. The drawing shows a spindle 1 which is adapted to support and rotate an optical disk D, and an electric motor 2 used to rotate the spindle 1. The electric motor 2 receives its energy from a battery 3.

As was noted above, the invention proposes to use mechanical energy to assist in accelerating the spindle 1 and disk D, and for this purpose the disk drive unit comprises a loading mechanism 4 for loading mechanical energy, a storage mechanism 5 for storing the energy which was loaded, and a release mechanism 6 to release stored energy to the spindle 1 in order to assist in accelerating the spindle 1. Preferably, the energy loaded into the storage mechanism 5 can be released in a step-wise manner so that the spindle 1 can be accelerated a plurality of times with one load of energy in the storage mechanism 5.

The embodiment shown in FIG. 1 has two loading mechanisms 4A and 4B, wherein loading mechanism 4A is adapted to load energy from a user who provides energy during insertion of a disk D into the disk drive unit, while loading mechanism 4B is adapted to use energy provided by the spindle 1 during deceleration.

FIGS. 2 and 3 very schematically show a practical embodiment of a disk drive unit. They show the spindle 1 and the circumference of the disk D. They also show the loading mechanism 4A, the loading mechanism 4B, the storage mechanism 5, and the release mechanism 6.

The loading mechanism 4A comprises a gear rack 7 which is operated upon insertion of a disk (or cartridge). If the disk is accommodated in a cartridge, it is possible to have a direct push engagement between the cartridge of the disk D and the gear rack 7. With a bare disk, the disk drive unit may be provided with a drawer for accommodating the disk. During insertion of the disk D into the disk drive unit, the gear rack 7 is in engagement with a gear wheel 8 so that the translatory movement of the gear rack 7 is transformed into a rotational movement of a drive shaft 9 onto which the gear wheel 8 is mounted. Conveniently, the gear rack 7 will be provided with a mechanism to disengage the gear rack 7 from the gear wheel 8 when the gear rack 7 is returned to its original position, i.e. when the disk D is ejected again. Such systems are known per se.

One end of the drive shaft 9 is provided with a unidirectional coupling 10, coupling the drive shaft 9 to a stationary part such that a rotation in one direction is allowed and rotation in the opposite direction is prevented. Any known coupling may be used here. The drive shaft 9 may be slidable in axial direction (upwardly in FIG. 2) by means of an actuator 15. A clamp 11 may be used to bring the drive shaft back into its original position.

FIG. 2 also shows the loading mechanism 4B. It comprises a shaft 12 mounted on the spindle 1 and rotationally coupled thereto. The shaft 12 comprises a first transmission member, such as a friction or gear wheel 13 adapted to come into engagement with a mating second transmission member, such as a friction or gear wheel 14 which is slidable in axial direction along with the drive shaft 9. By sliding the drive shaft 9 and the gear wheel 14 in axial direction by means of actuator 15, the gear wheel 14 comes into engagement with the gear wheel 13 on the spindle shaft 12. During acceleration and constant rotation of the disk, the gear wheels 13, 14 are out of engagement owing to the clamp 11. When the motor 2 is stopped and the spindle 1 is not driven anymore, the shaft 9 is moved to bring the gear wheels 13 and 14 into engagement, and the rotational energy of the spindle 1 will be transferred to the drive shaft 9 thereby.

FIGS. 2 and 3 also illustrate schematically the storage mechanism 5 for storing mechanical energy. The storage mechanism 5 is provided with a mechanical spring, in this case a spiral spring 16. At one end, the spiral spring 16 is connected to the drive shaft 9 of the loading mechanism 4, in this case via an overload protection means 17. This overload protection means 17 may be of any known construction, such as a slip coupling or the like. The axis of the spiral spring 16 is aligned with the axis of the drive shaft 9, and rotation of the drive shaft 9 will wind up the spiral spring 16, thereby storing energy in the spring.

The other end of the spiral spring 16 is fixed to the release mechanism 6, which in this case comprises a release means such as a driving wheel 18 to which the spring 16 is fixed. The driving wheel is rotatable about an axis 19 which is aligned with the axis of the spiral spring 16 and of the drive shaft 9. The driving wheel 18 comprises a plurality of driving cams 20 equally spaced around the circumference of the driving wheels 18 and having an outer friction surface 21 adapted to engage an engagement surface 22 at the substantially cylindrical outer circumference of a driven wheel 23 fixed to the spindle 1. The release mechanism 6 further comprises a locking means 24, here including an arm 25 pivotable about a pivot 26 at one end and comprising a catch 27 at the other end. The catch 27 is adapted to hook behind the driving cams 20 on the outer circumference of the driving wheel 18. The locking means 24 is provided with a solenoid or other actuator 28 in order to operate the locking means 24 to either catch or release one of the driving cams 20. The axis of the pivot 26 in this case runs parallel to the axis 19 of the driving wheel 18.

The disk drive unit and/or the device containing the disk drive unit will comprise a CPU and software to control the parts of the disk drive unit for a proper operation thereof.

Operation of the disk drive unit is as follows:

When a disk is loaded into the disk drive unit, the gear rack 7 is moved and the gear wheel 8 is rotated. The drive shaft 9 will then rotate in a direction such that the spiral spring 16 is wound up. When the disk drive unit is started in order to rotate the spindle 1 and the disk D supported thereby, the actuator 28 of the locking means 24 is actuated and the arm 25 will pivot around the pivot 26. As a result, the catch 27 will be released from the driving cam 20, the tension of the spiral spring 16 exerted on the driving wheel 18 will rotate said wheel 18, and the friction surface 21 of one of the driving cams 20 will come into engagement with the engagement surface 22 of the driven wheel 23, so that the spindle 1 is driven by the driving wheel 18. Consequently, the spindle 1 will be accelerated and, as the electric motor 2 is actuated as well, the spindle 1 will be brought to its normal operating rotational speed in order to read or write data from or to the disk D. Preferably, the electric motor 2 will be actuated during or after acceleration of the spindle, since this will facilitate control of the motor (starting is difficult in standstill as the electronics is unaware of the relative position of the poles) and reduce the power consumption further.

Shortly after its release by the catch 27 of the locking means, the driving cam 20 it is brought into the locking position again (for example by de-energizing of the solenoid 28 and a spring returning the catch 27) so that the next driving cam 20 arriving at the locking means 24 will be caught by the catch 27, and the driving wheel 18 will be stopped. In this manner, it is possible to release the energy of the spiral spring 16 in a step-wise manner, so that the energy of the spiral spring 16 can be used to accelerate the spindle 1 a plurality of times, preferably dozens of times.

When the electric motor 2 of the disk drive unit is de-energized, the drive shaft 9 will be shifted in axial direction such that the gear wheels 13 and 14 come into engagement with each other and the rotational energy in the spindle 1 will be transmitted to the drive shaft 9. Rotation of the drive shaft 9 will result in the spiral spring 16 being wound up (further) to a certain extent. Consequently, a portion of the accelerating energy provided by the storage mechanism 5 to the spindle 1 is given back to the storage mechanism 5.

The mechanism according to the invention significantly reduces energy consumption of the disk drive unit, resulting in a longer battery life of the mobile device in which the disk drive unit is mounted.

FIG. 4 shows an alternative structure of the drive shaft/spindle structure. In this case, the driving wheel 18 has one driving cam 29, while the driven wheel 23 has a plurality of driven cams 30. The driven cams 30 have an engagement surface 31 which is engaged by the driving cam 29. In this embodiment, the transmittal of forces between the driving wheel 18 and the driven wheel 23 is not based on frictional contact, but there is an impinging contact between the two wheels (engagement based on shape rather than force). In this embodiment, the driving wheel 18 will rotate 3600 in each driving step, determined by a locking means or the like, as in the former embodiment. The driving cam 29 may rotate more than half a revolution before it hits the respective driven cam 30 so that a quick acceleration can be obtained as the driving cam 29 will have a high speed when it impinges upon the driven cam. It is also possible to provide driving wheel 18 with e.g. two driving cams 29. Alternatively, two drive shafts 9 may be used which are positioned symmetrically with respect to the spindle 1 in order to engage the spindle or driven wheel 23 in a symmetrical way. This reduces energy losses due to bearing losses and wear, since there is now a symmetrical transmittal of torque to the spindle.

It is further shown in FIG. 4 that the axis 19 of the driving cam 29 of the release mechanism 6 is not aligned with the drive shaft 9 of the energy loading mechanism 4A. In this embodiment, the spring 16 is fixed to a transmission member 32 that is in engagement with a mating transmission member 33 on the axis 19 of the driving cam 29. This structure enables a high speed of the driving cam without an excessive unwinding of the spring 16.

FIG. 4 also shows an ejection mechanism 34 comprising a loading member 35, a storage mechanism in the form of a torsion spring 36, and also a release mechanism not shown here. Such ejection mechanisms for ejecting the disk (cartridge) from the device are known per se in the prior art.

FIG. 5 shows a further alternative for the release mechanism 6 of the disk drive unit. The release mechanism 6 comprises a driven wheel 23 as in FIGS. 2, 3 comprising an engagement surface 22. The driving wheel 18 or spindle 19 comprises a driving cam 37 which is connected to the spindle 19 or the driving wheel 18 via a leaf spring 38 or some other flexible member allowing the driving cam 37 to frictionally engage the engagement surface 22 of the driven wheel 23. The catch 27 of the locking means 24 is adapted to hold and release the driving wheel, in this case by means of the driving cam 37. This release mechanism will enable a smooth release of energy to the spindle 1.

From the above it will be clear that the invention provides a disk drive unit which has a very low energy consumption.

The invention is not limited to the embodiments shown in the drawing and described hereinbefore, and may be varied in different ways within the scope of the appended claims. Features of the various embodiments shown or described may be combined, while specific features may be replaced by alternatives.

In the specification and claims, the use of the expressions “a” or “an” does not exclude a plurality thereof, and the expression “comprising” does not exclude additional elements or steps. A single processor or unit may fulfil the functions of several means recited in the claims.

As an example of alternative structures, it would be possible to make the shaft of the spindle axially slidable instead of the drive shaft, in order to bring the second loading mechanism into and out of engagement with the storage mechanism. Instead of a flat spiral spring (which is very compact and therefore very suitable for mobile applications), it is possible to use an alternative mechanical spring, such as a torsion spring, or even a pneumatic spring or the like. The disk drive unit may have a separate ejection mechanism for ejecting the disk from its operating position into its removal position (as is shown in FIG. 4), but this ejection mechanism may also be combined with the energy loading and storage mechanism according to the invention. Furthermore, it is conceivable to leave out the storage mechanism and to couple the loading mechanism and the release mechanism directly so that the loaded energy is directly transferred to the spindle. In that case, the spindle rotation must be started immediately during insertion of the disk.

In an alternative arrangement, the disk drive unit is not arranged in the mobile device, but in the cartridge of the disk to be used in the mobile device. The energy loading mechanism comprises a means for engaging a part of the mobile device in order to load the storage mechanism upon insertion of the disk cartridge into the mobile device. Such means are known for opening parts of a cartridge to expose the disk within the device. Electrical contacts should be present for a control of actuators in the cartridge by the CPU in the mobile device.

In the presently preferred embodiments, the disk is an optical data disk. However, it should be understood that the invention may be used for all kinds of disks, e.g. ferro-electric, magnetic, magneto-optical, optical, near-field, active charge storage disks or other disks using combinations of these techniques or any other reading and/or writing techniques.

1. A disk drive unit for a removable disk to be used in a device for reading and/or writing the disk, in particular for use in mobile devices, which disk drive unit comprises a spindle (1) positioned within the disk drive unit and adapted to support the disk D rotatably in an operating position, an energy loading mechanism (4A) adapted to load mechanical energy, which is provided by the user when the disk is brought into its operating position in the device, and a release mechanism (6) which is adapted to release said loaded mechanical energy, characterized in that the release mechanism (6) is connectable to the spindle (1) in order to release the loaded energy to the spindle (1), thereby assisting in bringing the disk (D) into rotation.

2. A disk drive unit according to claim 1, comprising a storage mechanism (5) connected at one end to the loading mechanism for storing the mechanical energy loaded by the loading mechanism and connected at another end to the release mechanism (6) to release the stored mechanical energy.

3. A disk drive unit according to claim 2, wherein said release mechanism (6) is adapted to release the stored energy stepwise.

4. A disk drive unit according to claim 3, wherein said release mechanism (6) comprises a release means (18) which selectively engages with the spindle (1).

5. A disk drive unit according to claim 4, wherein the release means (18) comprises at least one driving cam (20;29;37) rotatable about an axis (19) while said spindle (1) comprises an engagement surface (22;31) engageable by said at least one driving cam (20;29;37) of the release means (18), such that only one driving cam (20;29;37) engages with the engagement surface (22;31) of the spindle (1) during acceleration of the spindle (1).

6. A disk drive unit according to claim 5, wherein the engagement surface (22) of the spindle (1) is formed on the substantially cylindrical outer circumference of a driven wheel (23), and the at least one driving cam (20;37) is adapted to frictionally engage with said substantially cylindrical engagement surface (22).

7. A disk drive unit according to claim 6, wherein the release means (18) comprises a plurality of driving cams (20).

8. A disk drive unit according to claim 5, wherein the engagement surface (31) of the spindle (1) is formed on a plurality of driven cams (30), which are engageable by said at least one driving cam (29) of the release means (18).

9. A disk drive unit according to claim 5, wherein said release mechanism (6) comprises a locking means (24) for locking the driving cam (20;29;37) of the release mechanism (6) against rotation and for unlocking the driving cam (20;29;37) of the release mechanism (6) when acceleration of the spindle (1) is required.

10. A disk drive unit according to claim 9, wherein said locking means (24) comprises a catch (27) which is configured to engage with the driving cam (20;29;37) of the release mechanism (6) such that, when the locking means (24) unlocks the rotation of the driving cam (20;29;37), the catch (27) of the locking means (24) will engage with an immediately following driving cam (20;29;37) along the circumference of the driving wheel (18).

11. A disk drive unit according to claim 9, wherein said release mechanism (6) comprises an actuator (28) which is adapted to operate said locking means (27).

12. A disk drive unit according to claim 1, wherein said loading mechanism (4) comprises a gear rack (7) which is adapted to be moved along with the disk during insertion of the disk (D) and a gear wheel (8) which engages with the gear rack (7) during said insertion of the disk and which is rotatably connected to the storage mechanism (5) or to the release mechanism (6) via a drive shaft (9).

13. A disk drive unit according to claim 1, wherein said drive shaft (9) is operatively connected to a unidirectional coupling (10) which is adapted to enable only one direction of rotation of said drive shaft (9).

14. A disk drive unit according to claim 1, comprising a second loading mechanism (4B) which is connectable to the spindle (1) in order to load mechanical energy from the spindle (1) during deceleration of the spindle (1).

15. A disk drive unit according to claim 14, wherein said second loading mechanism (4B) comprises a first transmission member (13) mounted to the spindle (1) via a shaft (12), and a second transmission member (14) which is slidably moveable in axial direction of the drive shaft (9) such that the slidable second transmission member (14) is enabled to rotate along with said drive shaft (9), and wherein said transmission members (13,14) only engage during a deceleration of the rotation of the spindle (1) in order to transmit rotational energy from the spindle (1) via the drive shaft (9) to the storage mechanism (5).

16. A disk drive unit according to claim 15, wherein said second loading mechanism (4B) comprises an actuator (15) for causing said sliding movement of said slidable second transmission member (14).

17. A disk drive unit according to claim 2, wherein said storage mechanism (5) comprises at least one spring member (16) which is adapted to store mechanical energy and which is connected at one end to said energy loading mechanism (4) and at another end to said release mechanism (6).

18. A disk drive unit according to claim 17, wherein said spring member (16) is a mechanical spring member, e.g. a spiral or torsion spring.

19. A disk drive unit according to claim 18, wherein said storage mechanism (5) comprises an overload protection means (17) adapted to prevent an overload of said storage mechanism.

20. A disk drive unit according to claim 1 to be built in into a device for reading and/or writing a data disk, wherein the spindle (1) is adapted to be coupled to a hub of the disk, comprising an electric motor (2) operatively coupled to the spindle (1) to rotate the spindle (1).

21. Mobile device having a housing comprising the disk drive unit according to claim 20.

22. A disk cartridge for use in a reading/writing device, comprising a disk and the disk drive unit according to claim 1.

23. A disk drive unit for a removable disk, in particular for use in mobile devices, which disk drive unit comprises a spindle (1) positioned within the disk drive unit and adapted to support the disk (D) rotatably in an operating position, a loading mechanism (4B) adapted to load mechanical energy, a storage mechanism (5) for storing said mechanical energy, and a release mechanism (6) which is adapted to release said stored mechanical energy, characterized in that the release mechanism (6) is adapted to release the stored energy stepwise.
